(19) United States
(12) Patent Application Publication
(10) Pub. No.: US 2005/0280690 A1
(43) Pub. Date: Dec. 22, 2005

(54) Thermal processor employing a drive band

(76) Inventor: Duane A. Preszler, River Falls, WI (US)

Correspondence Address: Pamela R. Crocker;Patent Legal Staff, Eastman Kodak Company, 343 State Street, Rochester, NY, 14650-2201, US

(21) Appl. No.: 10/874,126

(22) Filed: Jun. 22, 2004

(51) Int. Cl. B41J 2/315

(52) U.S. Cl. 347/171

(57) ABSTRACT

A thermal processor for thermally developing an image in an imaging material. The thermal processor includes an oven, a plurality of rollers, and a drive band. The rollers each have an outer surface, and are positioned such that the outer surfaces contact an imaging material and form a transport path through the oven. The drive band contacts a least a portion of the outer surface of up to all of the rollers and via the contact drives each roller such that contact between the imaging material and the outer surfaces of the rollers moves the imaging material through the oven along the transport path.

### FIELD OF THE INVENTION

The present invention relates generally to an apparatus and method for processing an imaging material, and more specifically an apparatus and method employing a drive band for driving rotatable members that form a transport path through a thermal processor.

### BACKGROUND OF THE INVENTION

Photothermographic film generally includes a base material coated on at least one side with an emulsion of heat sensitive materials. Once the film has been imaged (i.e., subjected to photo-stimulation by optical means, such as with laser light), the resulting latent image is developed through the application of heat to the film. In general, the uniformity in the density of the developed image is affected by the manner in which heat is transferred to the emulsion of heat sensitive material. Non-uniform heating can result in uneven density of the developed image. Uneven contact between the film and any supporting structures during the development process can also produce visible marks, patterns, and other visual artifacts on the developed image. Therefore, the uniform transfer of heat to the heat sensitive materials is critical in producing a high quality image.

Several types of processing machines have been developed in efforts to achieve optimal heat transfer to sheets of photothermographic film during processing. One type of processor, commonly referred to as a “flat bed” processor, typically comprises an oven enclosure within which a number of spaced rollers are configured so as to form a generally horizontal transport path through the oven, wherein some type of heat source(s) is positioned along and in proximity to the transport path. In one configuration, a plurality of upper rollers and a plurality of lower rollers are staggered in a horizontal direction and slightly overlap a horizontal plane in a vertical direction to form a corrugated, or sinusoidal-like, transport path through the oven. A drive system is employed to cause the rollers to rotate and move a piece of film through the oven along the transport path from an oven entrance to an oven exit. As the film moves along the transport path, the heat source(s) heats the film to a temperature necessary to develop the image.

While flat bed type processors are effective at developing photothermographic film, variations in image density and other visual artifacts can result if the transport rollers are not rotating at the same speed. For instance, if the rollers are rotating at different speeds, the film could potentially be stretched and/or compressed at different areas along the transport path, which could potentially cause the film to wrinkle. Additionally, if one roller is rotating at a slightly slower speed than a preceding roller along the transport path, the film may “lift” from the surface of the preceding roller potentially causing the film to wrinkle or to be heated differently relative to adjacent areas, thereby resulting in visible bands across the film. This latter phenomenon is sometimes referred to as “cross-width” or “cross-web” banding.

In efforts to reduce such defects, various drive systems have been employed in attempts to eliminate speed variations between rollers. One such system employs an elaborate gear system which is coupled to and drives the shaft of each of the roller where it extends through a wall of the oven enclosure. Another system employs a series of belts to the drive the rollers via pulleys which are coupled to the roller shafts where they extend from the oven enclosure. While such systems can reduce speed variations between rollers, variations still exist due to “play” in the gears and differences in belt tensions, especially as these systems age. Additionally, such systems do not address speed variations due to differences in shaft and surface diameters between rollers in the same thermal processor. Furthermore, these systems can be expensive to manufacture and difficult to maintain.

It is evident that there is a continuing need for improved photothermographic film developers. In particular, there is a need for a thermal processor having a drive system that substantially eliminates speed variations between rollers as described above that is both economical and simple to manufacture and maintain.

### SUMMARY OF THE INVENTION

In one embodiment, the present invention provides a thermal processor for thermally developing an image in an imaging material. The thermal processor includes an oven, a plurality of rotatable members, and a drive band. The rotatable members each have an outer surface, and are positioned so that the outer surfaces contact the imaging material and form a transport path through the oven. The drive band contacts a least a portion of the outer surface of each rotatable member and via the contact drives each rotatable member such that contact between the imaging material and the outer surfaces of the rotatable members moves the imaging material through the oven along the transport path.

By driving the outer surfaces of the rotatable members with the drive band, the outer surfaces of the rotatable members are driven at substantially equal speeds regardless of dimensional variations that may exist between the rollers. As a result, the present invention substantially reduces variations in image density and other physical defects that may occur during processing due to speed variations between the rotatable members. Additionally, the drive band is less complex and easier to maintain than gear and chain drive systems.

Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a side sectional view of one embodiment of a thermal processor according to the present invention.

FIG. 2 is a top sectional view of one embodiment of the thermal processor shown in FIG. 1.

FIG. 3 is a side sectional view of another embodiment of a thermal processor according to the present invention.

FIG. 4 is a side sectional view of another embodiment of a thermal processor according to the present invention.

FIG. 5A is a side sectional view illustrating one exemplary embodiment of a roller for use in a thermal process according to the present invention.

FIG. 5B is a cross sectional view of a roller employed by the thermal processor shown in FIG. 1.

FIG. 5C is a cross sectional view of a roller employed by the thermal processor shown in FIG. 3.

FIG. 6 is a block diagram illustrating a drive system for use with a thermal processor according to the present invention.

FIG. 7 is a side sectional view of another embodiment of a thermal processor according to the present invention.

### DETAILED DESCRIPTION OF THE INVENTION

The following is a detailed description of the preferred embodiments of the invention, reference being made to the drawings in which the same reference numerals identify the same elements of structure in each of the several figures.

Reference is made to U.S. patent application Ser. No. 10/815,027 entitled “Apparatus and Method For Thermally Processing An Imaging Material Employing a Preheat Chamber,” filed on Mar. 31, 2004, assigned to the same assignee as the present application, and herein incorporated by reference.

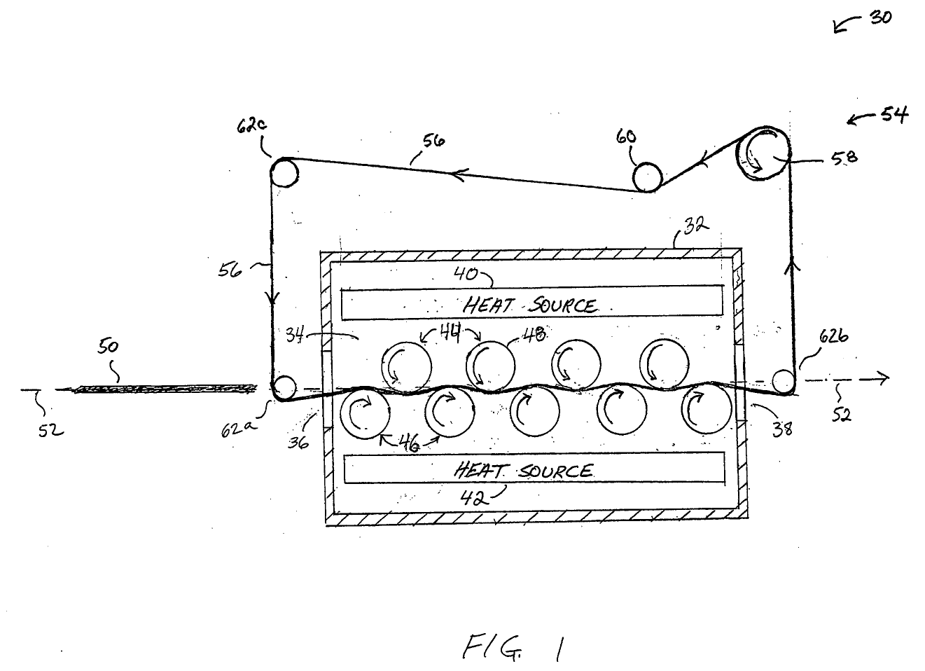

FIG. 1 is a cross-sectional view illustrating one exemplary embodiment of a thermal processor 30 employing a band drive in accordance with the present invention. Thermal processor 30 includes an enclosure 32 that forms an oven 34, having an entrance 36 and an exit 38, that encloses an upper and lower heat source, 40 and 42. Oven 34 further encloses a plurality of upper rollers 44 and lower rollers 46, with each of the rollers, 44 and 46, having an outer surface 48. The plurality of upper and lower rollers, 44 and 46, are rotatably mounted to opposite sides of enclosure 32 and positioned in a spaced relationship such that outer surfaces 48 contact an imaging material 50 and form a transport path 52 through oven 34 from entrance 36 to exit 38. In one embodiment, as illustrated, upper rollers 44 are horizontally offset from lower rollers 46 and are vertically positioned such that upper rollers 44 and lower rollers 46 overlap a horizontal plane such that transport path 52 is corrugated, or sinusoidal-like, in shape. A thermal processor having a similar roller configuration is described by U.S. Pat. No. 5,869,860 to Struble et al., which is herein incorporated by reference.

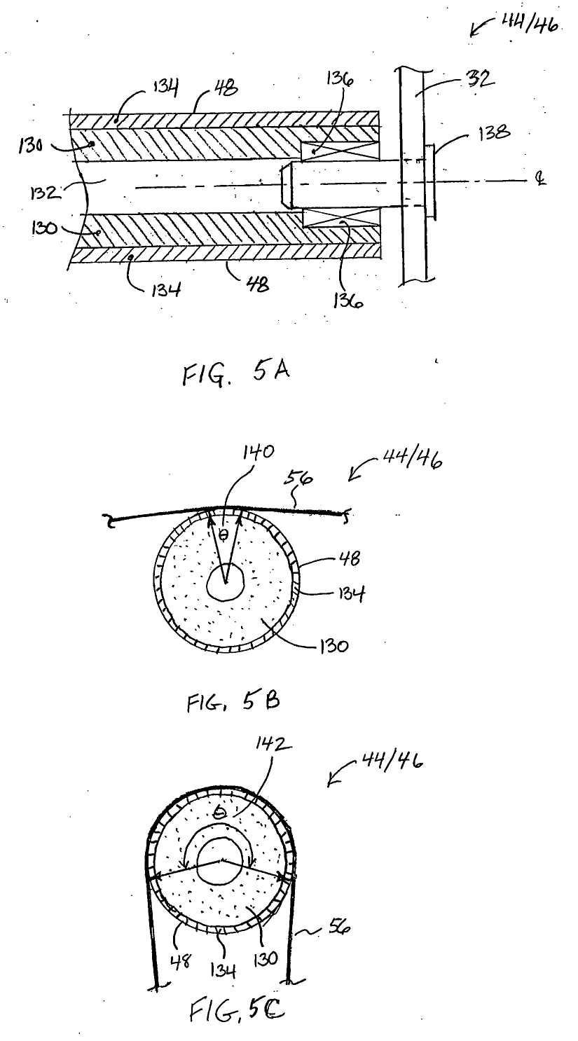

Thermal processor 30 further includes a drive system 54 which includes an endless drive band 56, a drive pulley 58, a tensioning roller 60, and a plurality of idler rollers 62. Drive band 56 is fed through oven 34 along sinusoidal-like transport path 52 and contacts and forms a wrap angle around a portion of the outer surface 48 of each upper and lower roller 44 and 46, thereby coupling each roller 44 and 46 with drive pulley 58. Idler rollers 62a and 62b are respectively positioned so as to maintain at least a minimum required wrap angle around the surfaces 48 of the first roller 46a and the last roller 46b. The wrap angles formed around surfaces 48 of rollers 44 and 46 is described in greater detail below by FIGS. 5A and 5B.

As illustrated by the directional arrow at 57, when drive pulley 58 is driven in a counter-clockwise direction, drive band 56 is driven through oven 34 along sinusoidal-like transport path 52 from entrance 36 to exit 38. As drive band 56 is driven through transport path 52 by drive pulley 58, contact between drive band 56 and rollers 44 and 46 causes upper rollers 44 to rotate in a counter-clockwise direction and lower rollers 46 to rotate in a clockwise direction. When imaging material 50 enters oven 34, contact with rotating rollers 44 and 46 causes imaging material 50 to be transported through oven 34 along transport path 52 from entrance 36 to exit 38. To reverse the direction of travel of imaging material 50 through oven 34, such as might be useful if a jam occurs, drive pulley 58 is driven in a clockwise direction. Drive pulley 58, tensioning roller 60, and idler rollers 62 can be “crowned” in order to provide tracking control of drive band 56.

As imaging material 50 moves through oven 34 along transport path 52, it is heated by upper and lower heat sources 40 and 42 to thereby develop a previously exposed image. Positioning the upper rollers 44 and lower rollers 46 as illustrated causes imaging material 50 to be bent or curved as it moves along transport path 52. Curving imaging material 50 in this fashion increases a column stiffness of imaging material 50 and enables imaging material 50 to be heated and transported through oven 34 without a need for nip rollers or other pressure transporting means.

By employing a drive band 56 that contacts and drives the outer surfaces 56 of each roller 44 and 46, the outer surfaces of rollers 44 and 46 are driven at substantially equal speeds regardless of variations in diameters between different rollers. As a result, thermal processor 30 substantially reduces variations in image density and other physical defects in imaging material 50 caused by speed variations between rollers. Additionally, drive system 54 employing drive band 56 is less complex and easier to maintain than other drive systems, such as chain or gear drive systems, which can reduce both the initial and operational costs of thermal processor 30.

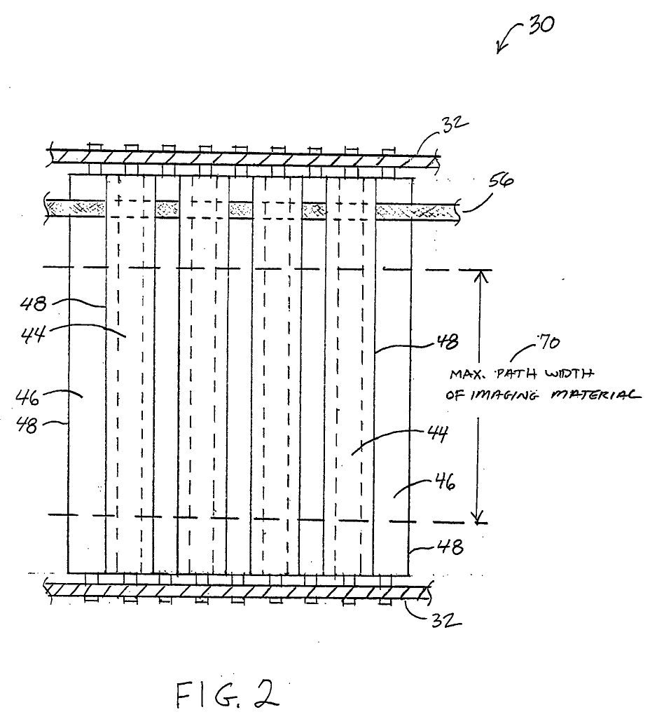

FIG. 2 is a top view illustrating portions of thermal processor 30 as illustrated by FIG. 1. As illustrated, drive band 56 is fed through sinusoidal-like transport 52 formed by upper and lower rollers, 44 and 46, such that drive band 56 contacts the surfaces 48 of rollers 44 and 46 and follows a path that is outside of a maximum path width 70 followed by imaging material 50. Thus, while drive band 56 follows the same transport path 52 formed by rollers 44 and 46, and contacts the same surfaces 48 as imaging material 50, drive band 56 does not interfere with the transport of imaging material 50 through oven 34.

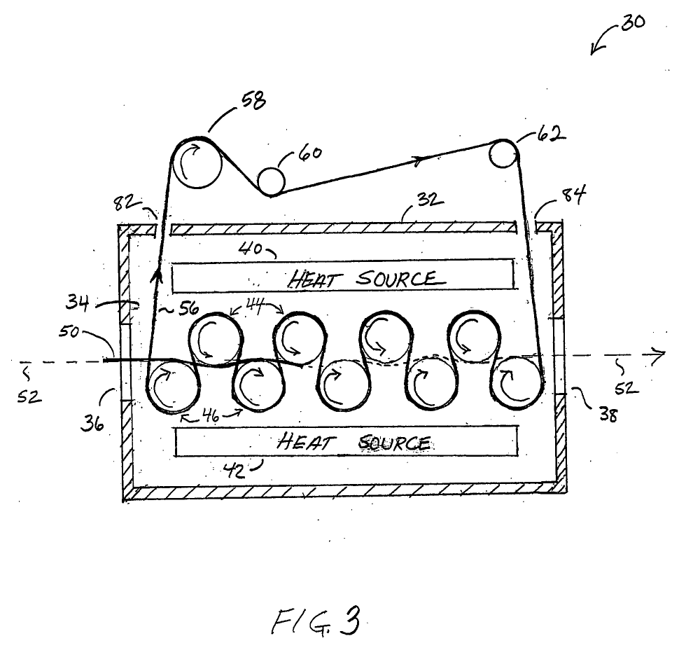

FIG. 3 is a cross-sectional view illustrating another exemplary embodiment of a thermal processor 30 employing a band drive in accordance with the present invention. As illustrated, rather than following transport path 52, drive band 56 is fed in a serpentine fashion through rollers 44 and 46 such that drive band 56 criss-crosses transport path 52 and contacts the outer surfaces 48 of rollers 44 and 46 opposite drive path 52. Additionally, rather than being fed through the ends of enclosure 32, such as through entrance 36 and 38, drive band 56 is fed into oven 34 via openings 82 and 84 through an upper portion of enclosure 32.

When drive band 56 is fed through rollers 44 and 46 in this fashion, drive band 56 must be driven in a direction from exit 38 to entrance 36 in order to cause upper rollers 44 to rotate in a counter-clockwise directions and lower rollers 46 to rotate in a clockwise direction and thereby cause rollers 44 and 46 to move imaging material 50 along transport path 52 from entrance 36 to exit 38. As such, drive pulley 58 must be driven in a clockwise direction to move imaging material through oven 34 from entrance 36 to exit 38, which is opposite the direction drive pulley 58 is driven to achieve the same transport direction when drive band 56 follows transport path 52, as illustrated by FIG. 1. As before, drive band 56 follows a path through rollers 44 and 46 that is outside of the maximum path width 70 followed by imaging material 50.

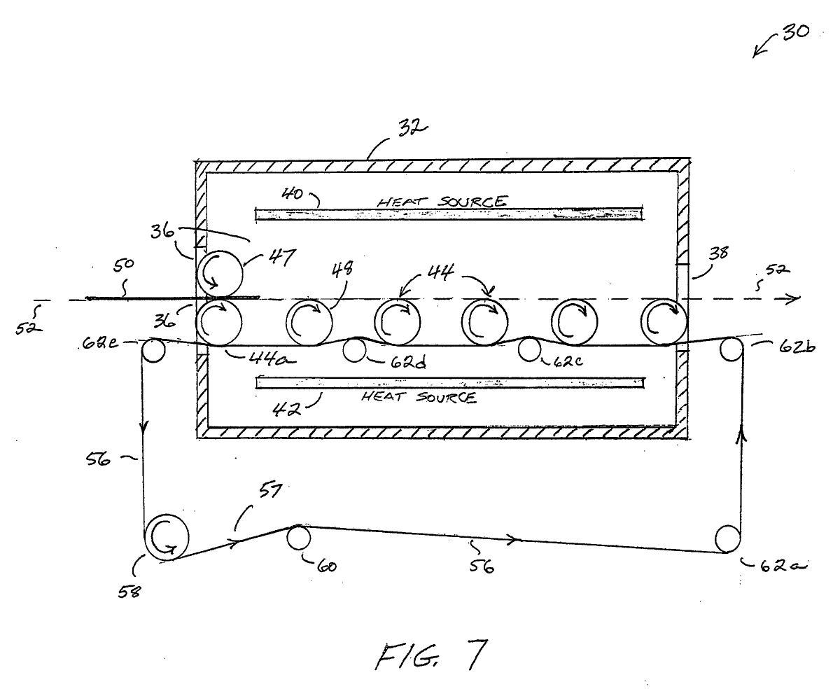

While FIG. 3 illustrates upper and lower rollers 44 and 46 as being offset both horizontally and vertically to form a sinusoidal-like transport path 52, the drive band configuration illustrated by FIG. 3 could also be employed to drive a single horizontally spaced row of rollers having no vertical offset and forming a substantially horizontal transport path, similar to that illustrated below by FIG. 7.

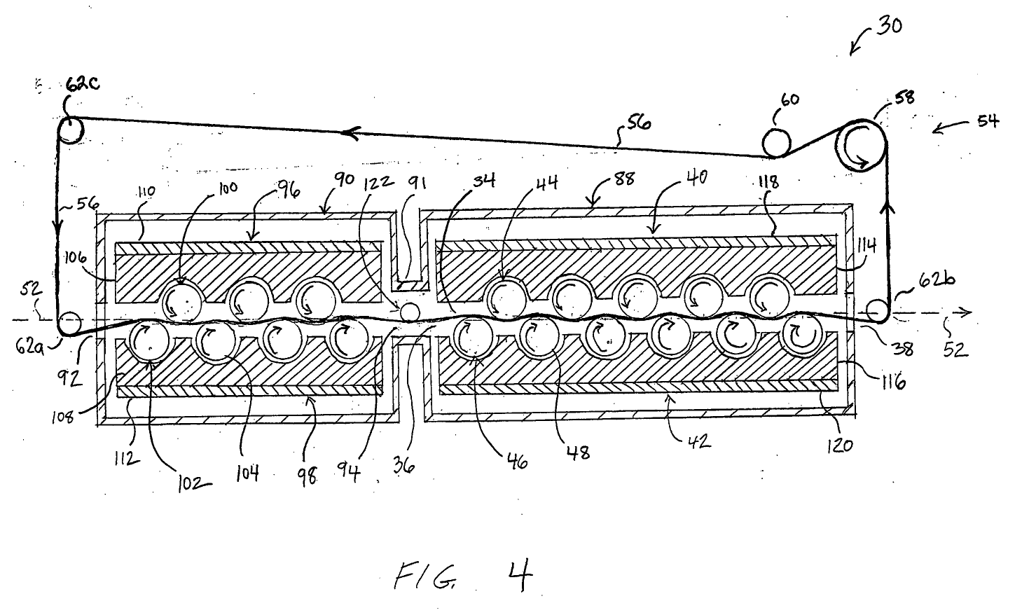

FIG. 4 is a cross-sectional view illustrating another exemplary embodiment of a thermal processor 30 in accordance with the present invention further including an enclosure 90 configured as a preheat chamber, and wherein enclosure 32 is configured as a dwell chamber 88. Thermal processor 30 is configured such that preheat chamber 90 heats imaging material 50 to a first temperature and dwell chamber 88 heats imaging material to a second temperature, wherein the first temperature is less than the second temperature. In one embodiment, as illustrated, preheat chamber 90 is thermally isolated from and coupled to dwell chamber 88 via a transition section 91. A thermal processor having a similar configuration is described by the previously incorporated U.S. patent application Ser. No. 10/815,027, entitled “Apparatus and Method For Thermally Processing an Imaging Material Employing a Preheat Chamber”, filed on Mar. 31, 2004.

Preheat chamber 90 has an entrance 92 and an exit 94, and includes upper and lower heat sources, 96 and 98, and a plurality of upper and lower rollers, 100 and 102, each roller having an outer surface 104. In a fashion similar to that of dwell chamber 88, the plurality of upper and lower rollers, 100 and 102, are rotatably mounted to opposite sides of preheat chamber 90 and positioned in a spaced relationship such that outer surfaces 104 contact imaging material 50 and form a transport path through preheat chamber 90 from entrance 36 to exit 38. In one embodiment, as illustrated, upper rollers 100 are horizontally offset from lower rollers 102 and are vertically positioned such that upper rollers 100 and lower rollers 102 overlap a horizontal plane such that the transport path through preheat chamber 90 is sinusoidal-like in shape. Together, upper and lower rollers 100 and 102, and upper and lower rollers 44 and 46 of dwell chamber 88 form a continuous transport path 52 for moving imaging material 50 through preheat chamber 90 and dwell chamber 88.

Upper and lower heat sources 96 and 98 of preheat chamber 90 respectively include heat plates 106 and 108 and blanket heaters 110 and 112. Upper and lower heat sources 40 and 42 of dwell chamber 88 respectively include heat plates 114 and 116 and blanket heaters 118 and 120. Blanket heaters 96, 98, 118, and 120, and heat plates 106, 108, 118, and 120 can be configured with multiple zones, with the temperature of each zone being individually controlled. In one embodiment, as illustrated, heat plates 106, 108, 118, and 120 are shaped so as to partially wrap around a portion of the circumference of rollers 44, 46, 100, and 102 such that the rollers are “nested” within their corresponding heat plate. By nesting rollers 44, 46, 100, and 102 within heat plates 106, 108, 114, and 116 in this fashion, the temperature of the outer surfaces 48 and 104 of the rollers 44, 46, 100, and 102 can be more evenly maintained and thereby provide more uniform heat transfer to imaging material 50.

Drive band 56 is continuously fed along sinusoidal-like transport path 52 through preheat chamber 90, transition section 91, and dwell chamber 88. In one embodiment, as illustrated, an idler roller 122 may be positioned in transition section 91 so that drive band 56 maintains at least a required minimum wrap angle around the surface 104 of the last roller 102 of preheat chamber and the surface 48 of the first roller 46 of dwell chamber 88. When drive pulley 58 is driven in a counterclockwise direction, as illustrated, drive band 56 is driven along transport path 52 from entrance 92 of preheat chamber 90 to exit 38 of dwell chamber 88. As a result, contact with drive band 56 causes lower rollers 46 and 104 to rotate in a clockwise direction and upper rollers 44 and 102 to rotate in a counter-clockwise fashion. When imaging material 50 enters preheat chamber 90, contact with rotating rollers 44, 46, 100, and 102 causes imaging material to move through preheat chamber 90 and dwell chamber 88 along transport path 52 from entrance 92 to exit 38.

By driving the surfaces 48 and 104 of rollers 44, 46, 100, and 102 with continuous band 56, the rollers of both preheat chamber 90 and dwell chamber 88 are driven such that surfaces 48 and 104 are driven at substantially equal speeds regardless of diameter variations that may exist between the rollers. As such, drive system 54 according to the present invention provides thermal processor 30 with a simple and economical way to match and control the roller surface speeds of rollers within a single chamber and between rollers of different chambers.

FIG. 5A is a lateral cross-sectional view illustrating portions of one exemplary embodiment of a roller 44/46 employed by thermal processor 30. Roller 44/46 includes a support shaft 130. In one embodiment, support shaft 130 is aluminum. In one embodiment support shaft 130 is tubular with a hollow interior 132. A sleeve of support material 134 surrounds the external surface of support shaft 130 and forms outer surface 48 that contacts imaging material 50 and drive band 56. In one embodiment, support material 134 comprises a silicon material.

Support shaft 130 includes a recessed area on each end which includes a bearing 136, or other low-friction device. In one embodiment, bearing 136 comprises a needle bearing. A stationary stub shaft 138 is mounted to a side of enclosure 138. Needle bearing 136 is slidably fitted over stub shaft 138 such that roller 44/46 is free to rotate about support shaft 138. As illustrated, stub shaft 138 extends through the side of enclosure 32. In other embodiments, stub shaft 138 can be mounted to an interior surface such that it does not extend through enclosure 32. In other embodiments, stub shaft 138 can be rotatable such that roller 44/46 rotates relative to enclosure 32 but is stationary relative to rotatable stub shaft 138.

FIG. 5A is a cross-sectional view of roller 44/46 illustrating an example wrap angle (θ) 140 formed by drive band 56 according to the configuration illustrated by FIG. 1. Due to either adjacent upper rollers 44 or idler rollers 62 in the case of lower rollers 46, or to adjacent lower rollers 46 in the case of upper rollers 44, drive band 56 is forced to wrap around at least a portion of the outer surface 48 of roller 44/46. A contact area and a coefficient of friction between drive band 56 and surface 48 causes roller 44/46 to rotate when drive band 56 is driven across surface 48.

Wrap angle 140, and thus the contact area between drive band 56 and surface 48, can be adjusted by adjusting the vertical offset between upper and lower rollers 44 and 46. The greater the wrap angle 140, the greater the contact area between drive band 56 and surface 48 and the greater an amount of torque that can be transmitted by drive band 56 to rollers 44, 46. Wrap angle 140 can be increased by moving upper and lower rollers 44 and 46 closer to one another in the vertical direction. Wrap angle 140 can be decreased by moving upper and lower rollers 44 and 46 further apart in the vertical direction. However, too small of a wrap angle 140 can result in the contact area between drive band 56 and surface 48 being reduced to a point where drive band 56 may slip during operation and result in poor speed control of rollers 44 and 46. In one embodiment, a wrap angle of four degrees was found to provide a contact area sufficient for drive band 56 to drive rollers 44 and 46. The contact area between drive band 56 and surfaces 48 of rollers 44 and 46 may also be adjusted by adjusting a width of drive band 56.

The coefficient of friction between rollers 44 and 46 and drive band 56 can be adjusted based on the type of materials used for drive band 56 and support material 134 which forms surface 48 of rollers 44 and 46. In one embodiment, as described above, support material 134 can be a silicon-based material. In one embodiment, drive band 56 comprises a substantially non-elastic material. In one embodiment, drive band 56 comprises a plastic film. In one preferred embodiment, the plastic film comprises a polyimide plastic, such as Kapton® from DuPont. In one embodiment, drive band 56 comprises a metallic material, which generally provides greater durability than a plastic material. Increasing the coefficient of friction increases the amount of torque that can be transmitted from drive band 56 to rollers 44 and 46. Increasing the coefficient of friction also enables a smaller drive angle 140 to be employed while still enabling drive band 56 to transmit a sufficient amount of torque to rollers 44 and 46. The amount of torque that can be transferred to rollers 44 and 46 can also be adjusted by adjusting the tension of drive band 56. The greater the tension, the greater the amount of torque that can be transferred to rollers 44 and 46 via the contact between surfaces 48 and drive band 56.

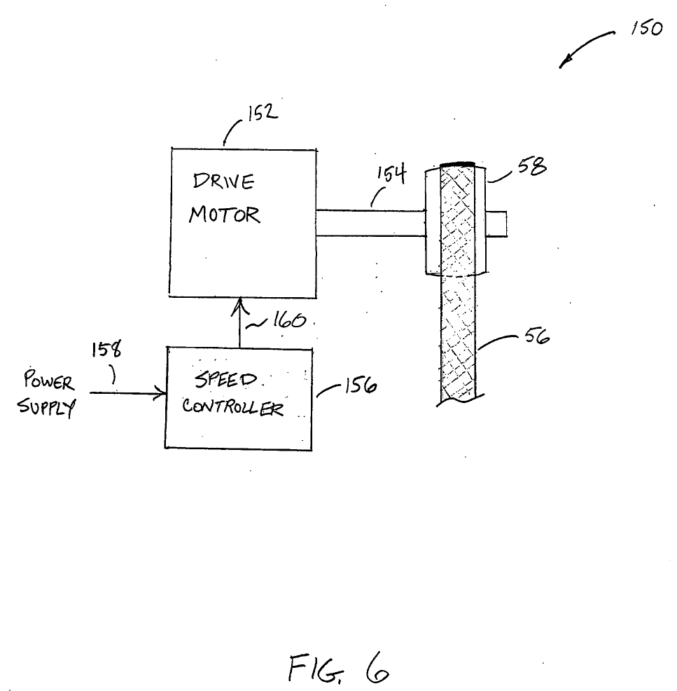

FIG. 6 is a block diagram illustrating one exemplary embodiment of a drive system 150 for driving drive band 56 of thermal processor 30. Drive system 150 includes a drive motor 152 that is coupled to and drives drive pulley 58 via a shaft 154. A speed controller 156 receives electrical power via a path 158 provides power to drive motor 152 via a path 160. Speed controller 156 controls the speed of drive motor 152, and thus the speed of drive pulley 58 and drive band 56, by controlling the power provided to drive motor 152. In one embodiment, drive motor 152 is a stepper motor and speed controller 156 controls the speed of stepper motor 152 by controlling the frequency of the electrical power provided to stepper motor 152 via path 160.

FIG. 7 is a side-sectional view illustrating another exemplary embodiment of a thermal processor 30 employing a drive band in accordance with the present invention. The plurality of rollers 44 are rotatably mounted to opposite sides of enclosure 32 and positioned in a spaced relationship such that outer surfaces 48 form a substantially horizontal transport path 52 through oven 34 from entrance 36 to exit 38. A first roller 44a of the plurality and a roller 47 form a nip at entrance 36.

Drive band 56 is fed through oven 34 from exit 38 to entrance 36 and is configured to contact surfaces 48 of rollers 48 on a side. of rollers 44 opposite transport path 52. Idler rollers 62b through 62e are positioned to maintain a necessary wrap angle of drive band 56 around surfaces 48 of rollers 44. In this fashion, drive band 56 can follow a path beneath the path followed by imaging material 50, such as the path having a width 70 as illustrated above by FIG. 2.

As illustrated by the directional arrow at 57, when drive pulley 58 is driven in a counter-clockwise fashion, drive band 56 is driven through oven 34 from exit 38 to entrance 36. As drive band 56 travels through oven 34, contact between drive band 56 and surfaces 48 of rollers 44 causes rollers 44 to rotate in a clockwise direction. When imaging material 50 enters oven 34, contact with rollers 44 causes imaging material 50 to be transported through oven 34 along transport path 52. Nip roller 47 is not directly driven by drive band 56, but rotates in a counter-clockwise direction from contact with imaging material 50.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

30 Thermal Processor
32 Enclosure
34 Oven
36 Oven Entrance
38 Oven Exit
40 Upper Heat Source
42 Lower Heat Source
44 Upper Roller
46 Lower Roller
48 Roller Outer Surface
50 Imaging Material
52 Transport Path
54 Drive System
56 Drive Band
58 Drive Pulley
60 Tensioning Roller
62 Idler Roller
70 Maximum Imaging Material Path Width
82 Enclosure Opening
84 Enclosure Opening
88 Dwell Chamber
90 Preheat Chamber
91 Transition Section
92 Preheat Chamber Entrance
94 Preheat Chamber Exit
96 Preheat Chamber Upper Heat Source
98 Preheat Chamber Lower Heat Source
100 Preheat Chamber Upper Roller
102 Preheat Chamber Lower Roller
104 Outer Surface of Preheat Chamber Roller
106 Heat Plate
108 Heat Plate
110 Blanket Heater
112 Blanket Heater
114 Heat Plate
116 Heat Plate
118 Blanket Heater
120 Blanket Heater
130 Roller Support Shaft
132 Roller Hollow Interior
134 Roller Support Material
136 Needle Bearing
138 Stub Shaft
140 Example Wrap Angle
142 Example Wrap Angle
150 Drive System
152 Drive Motor
154 Shaft
156 Speed Controller

1. A thermal processor for thermally developing an image in an imaging material, the thermal processor comprising:
an oven;
a plurality of rollers, each having an outer surface, the rollers positioned so that the outer surfaces of the rollers contact the imaging material and form a transport path through the oven; and
a drive band that contacts at least a portion of the outer surface of up to all of the rollers and via the contact drives the rollers contacting the drive band such that contact between the imaging material and the outer surfaces of the rollers moves the imaging material through the oven along the transport path.

2. The thermal processor of claim 1, wherein the drive band follows the transport path.

3. The thermal processor of claim 1, wherein the rollers comprise cylindrical rollers having a cylindrical outer surface and having a first end and a second end rotatably mounted to an enclosure that forms the oven.

4. The thermal processor of claim 3, wherein the rollers include bearings at the first end and second ends, and wherein the bearings are slidably fitted around a stationary shaft mounted to the enclosure.

5. The thermal processor of claim 4, wherein the bearings comprise needle bearings.

6. The thermal processor of claim 1 wherein the plurality of rollers includes a first group and a second group of horizontally spaced rollers, wherein the first group of rollers is horizontally offset from the second group of rollers and is vertically positioned such that the first group and second group of rollers overlap a horizontal plane so as to form a corrugated transport path, and wherein the drive band follows the corrugated transport path and forms a wrap angle around a portion of the outer surface of the rollers of the first group and second group of rollers.

7. The thermal processor of claim 1, further comprising a drive system configured to drive the drive band across the portion of the surface of each roller that contacts the drive band to cause the rollers to rotate.

8. The thermal processor of claim 7, wherein the drive system comprises a motor driving a drive pulley, and wherein the drive band forms an endless loop which is kept under tension by at least one tension roller and wraps around at least a portion of the drive pulley such that rotation of the drive pulley drives the drive band.

9. The thermal processor of claim 8, further including a speed controller configured to control the rotational speed of the driver pulley and drive band by controlling the rotational speed of the motor.

10. The thermal processor of claim 9, wherein the motor is a stepper motor and the speed controller controls the rotational speed of the motor by varying the frequency of electrical power provided to the motor.

11. The thermal processor of claim 1, wherein the drive belt comprises a substantially non-elastic material.

12. The thermal processor of claim 1, wherein a width of the drive band can be adjusted to adjust an amount of torque delivered by the drive band to the rollers.

13. The thermal processor of claim 1, wherein the drive band forms a wrap angle around a portion of a circumference of each roller with which the drive band is in contact and wherein the wrap angle can be adjusted to adjust an amount of torque delivered by the drive band to the rollers contacting the drive band.

14. The thermal processor of claim 1, wherein the drive band is kept under a tension, and wherein the tension can be adjusted to adjust an amount of torque delivered by the drive band to the rollers contacting the drive band.

15. The thermal processor of claim 1, wherein the drive belt comprises a plastic film.

16. The thermal processor of claim 15, wherein the plastic film comprises a polyimide film.

17. The thermal processor of claim 1, wherein the drive band comprises a metallic material.

18. A thermal processor for thermally developing an image in an imaging material, the thermal processor comprising:
a first chamber including a first plurality of rollers, each having an outer surface, the rollers positioned so that the outer surfaces of the rollers contact the imaging material and form a transport path through the first chamber;
a second chamber including a second plurality of rollers, each having an outer surface, the rollers positioned so that the outer surfaces of the rollers contact the imaging material and form a transport path through the second chamber; and
a single drive band that contacts at least a portion of the outer surface of each roller of the first and second pluralities of rollers, and via the contact drives each rollers such that contact between the imaging material and the outer surfaces of the rollers moves the imaging material through the first and second chambers along the corresponding transport paths.

19. The thermal processor of claim 18, wherein the drive band follows the transport path through the first chamber and the second chamber.

20. The thermal processor of claim 18, wherein the first chamber comprises a preheat chamber configured to heat the imaging material from an ambient temperature to a first temperature, and wherein the second chamber comprises a dwell chamber to heat the imaging material from the first temperature to a second temperature.

21. The thermal processor of claim 18, wherein a speed at which the drive band drives the rollers is controllable to control a speed of the surface of each roller of the first and second pluralities, to thereby control a speed at which the imaging material moves through the first and second chambers.

22. A thermal processor for thermally developing an image in an imaging material, the thermal processor comprising:
means for transporting the imaging material through the thermal processor, the means comprising a plurality rollers, each having an outer surface, the rollers positioned so that the outer surfaces of the rollers contact the imaging material and form a transport path through the thermal processor; and
means for driving the rollers via contact with the outer surfaces of the rollers such contact between the imaging material and the outer surfaces of the rollers moves the imaging material through the thermal processor along the transport path.

23. The thermal processor of claim 22, wherein the means for driving the rollers contacts the outer surfaces of the rollers via the transport path.

24. The thermal processor of claim 22, further comprising:
means for controlling a speed at which the imaging moves through the thermal processor along the transport path.

25. The thermal processor of claim 22, wherein the outer surfaces of the rollers are cylindrical.

26. The thermal processor of claim 22, wherein the means for driving the rollers comprises a drive band.

27. A method of operating a thermal processor for thermally developing an image in an imaging material, the method comprising:
providing a plurality of rollers, each having a cylindrical outer surface, the rollers positioned so that the cylindrical outer surfaces contact the imaging material and form a transport path through the thermal processor; and
driving the cylindrical outer surfaces of the rollers through contact with a drive band to cause the rollers to rotate such that contact between the imaging material and the cylindrical outer surfaces moves the imaging material through the thermal processor along the transport path.

28. The method of claim 27, further comprising:
feeding the drive band through the thermal processor via the transport path such that the drive band contacts the cylindrical surfaces via the transport path.

29. The method of claim 27, further comprising:
controlling a speed of the drive band to control a speed at which the imaging material-moves through the thermal processor.

30. A thermal processor for thermally developing an image in an imaging material having an upper and a lower surface, the thermal processor comprising:
a plurality of horizontally spaced upper rollers each having a cylindrical outer surface positioned to contact the upper surface of the imaging material;
a plurality of horizontally spaced lower rollers each having a cylindrical outer surface positioned to contact the lower surface of the imaging material, wherein the lower rollers are horizontally offset from the upper rollers and vertically offset such that the lower rollers and upper rollers overlap a horizontal plane so as to form a sinusoidal-like transport path through the thermal processor; and
an endless drive band that follows the transport path and forms a wrap angle around at least a portion of the cylindrical outer surface of each upper and lower roller and through contact with the cylindrical outer surfaces causes each upper and lower roller to rotate such that contact between the imaging material and the upper and lower rollers moves the imaging material through the thermal processor along the transport path.

31. The thermal processor of claim 30, further including a drive system that controls a rotational speed of the endless drive band to control a surface speed of each of the upper and lower rollers to thereby control a speed at which the imaging material moves through the thermal processor.

32. The thermal processor of claim 30, wherein the drive band comprises a plastic film.
